(19) United States
(12) Patent Application Publication
(10) Pub. No.: US 2020/0175557 A1
(43) Pub. Date: Jun. 4, 2020

(54) METHODS AND SYSTEMS FOR INCENTIVIZED JUDGING OF ARTISTIC CONTENT

(71) Applicant: MyMy Music Inc., Minneapolis, MN (US)

(72) Inventors: Shawn Pouliotte, Woodinville, WA (US); Joseph Orrie Morris, Shoreview, MN (US)

(21) Appl. No.: 16/701,486

(22) Filed: Dec. 3, 2019

Related U.S. Application Data
(60) Provisional application No. 62/775,226, filed on Dec. 4, 2018.

(51) Int. Cl. G06Q 30/02; G10H 1/00; G06Q 50/10

(52) U.S. Cl. CPC G06Q 30/0282; G10H 1/00; G10H 2240/075; G10H 2240/011; G06Q 50/10

(57) ABSTRACT

Methods and systems for providing crowdsourced creative works including receiving creative works such as music in a digital format, providing the creative works to judges in a random and anonymous manner, receiving scores of the creative works from the judges, calculating a cumulative score using the scores received from the judges and including the creative works in a subset of works available to consumers on an digital platform only if the cumulative score qualifies for inclusion based upon a threshold value. The judges may be evaluated for quality, and only the scores of those judges having sufficient quality may be included in the cumulative scores of the creative works. The quality of the judges may be determined using the popularity of past creative works judged by the judges as compared to the scores provided by the judges.

### BACKGROUND

Traditionally, professional artists produce works which are available to the public for purchase through stores. Depending upon the artistic media, such artists work with individuals such as agents, publicists, producers, and others to gain recognition and promote their works, though gaining the support of these individuals could be difficult. On their own, however, artists found it difficult to market their work as they had limited ability to access the public in meaningful numbers.

With the growth of the internet, individual artists now have much easier access to the public. Anyone can post content online, where it is widely available. However, because it is so easy to put material on the internet, there has been an explosion of content, much of it is poor quality. It can be difficult to impossible for the public to find high quality artistic works in the vast and un-curated content of the internet.

Even though the online community may be best suited to identify which creative works are likely to be popular, it has been difficult to utilize the online community for this purpose. For example, systems which include consumer reviews of artistic work are helpful but are subject to manipulation and are far from adequate. A system is needed to efficiently and effectively curate crowd sourced artistic works so that members of the public can find the types of high quality artistic works, created by a broad range of content creators, in which they are interested.

### SUMMARY

Various embodiments described herein include methods and systems for providing crowdsouced creative works that have been curated by judges. In some embodiments, the method for providing crowdsourced creative works includes receiving creative works in a digital format, providing the creative works to judges in a random and anonymous manner, receiving scores of the creative works from the judges, calculating a cumulative score using the scores received from the judges, and including the creative works in a subset of works available to consumers on an digital platform only if the cumulative score qualifies for inclusion based upon a threshold value. The digital platform may be a service providing electronic transmission through the internet or through an application, for example. In some embodiments, the creative work may be a piece of music such as an audio recording of a song. In some embodiments, the method may include streaming the creative works in the subset of creative works to consumers on demand. In some embodiments, the creative works for which the cumulative scores do not qualify for inclusion are not provided to consumers on the digital platform.

In some embodiments, any consumer may act as a judge, but only the scores of a subset of judges are used for calculating the cumulative score. For example, the subset of judges may be those judges having quality scores above a threshold value. The quality scores of the judges may be determined using the popularity of plurality of creative works scored by the judges. In some embodiments, the judges may be unaware of whether or not their scores count in the cumulative scores of the creative works. The scores received from the judges comprise numerical scores or category placements, for example.

In some embodiments, the method may also include monitoring amount of consumption of the creative works by consumers and providing a share of revenue attributed to each creative work to the judges who approved the creative work and who also have quality scores above a threshold value, wherein the share of revenue attributed to each creative work is dependent upon the amount of consumption of the work by consumers. In some such embodiments, the revenue earned by the digital platform may be split between a digital platform service, creators of the creative works, and judges.

In various other embodiments, the method for providing crowdsourced creative works includes receiving creative works in a digital format, providing the creative works to judges in a random and anonymous manner, receiving scores of the creative works from the judges, comparing a quality score for each judge to a threshold quality score to determine which judges are high quality judges, calculating cumulative scores for the creative works using only the scores received from high quality judges, and including the creative works in a subset of works available to consumers on a digital platform service only if the cumulative score qualifies for inclusion based upon a threshold value. In some embodiments, the creative works may be pieces of music such as audio recordings of songs, the method may also include streaming the pieces of music to consumers. The judges may be unaware of whether or not they qualify as high quality judges.

The method may further include monitoring an amount of consumption of each creative work and calculating a share of revenue attributed to each creative work to be provided to the judges. The share of revenue attributed to each creative work may be dependent upon the amount of consumption of the work. In some embodiments, revenue may only be shared which the judges who qualify as high quality judges.

Various other embodiments include digital creative content provider systems. In some embodiments, the digital creative content provider includes a provider server configured to receive creative works in a digital format, provide the creative works to judges in a random and anonymous manner, receive a score of the creative works from the judges, calculate a cumulative score for the creative works from the judges, and make the creative works available on a digital platform to consumers only if the cumulative score qualifies based upon a threshold inclusion value. The server may be further configures to calculate quality scores of a judges using scores of creative works provided by the judges in the past and compare the quality scores of the judges to a threshold quality score. In some embodiments, only the scores of judges who qualify for judging based upon their quality scores may be included in the cumulative scores of the creative works. In some embodiments, the server may be further configured to monitor an amount of consumption of each creative work and calculate a share of revenue attributed to each creative work to be provided to the judges, wherein the share of revenue attributed to each creative work is dependent upon the amount of consumption of the work.

### BRIEF DESCRIPTION OF THE DRAWINGS

The following drawings are illustrative of embodiments and do not limit the scope of the invention. The drawings are not necessarily to scale and are intended for use in conjunction with the following detailed description. Embodiments of the invention will be described with reference to the drawings, in which like numerals may represent like elements.

FIG. 1 is representative diagram of a system for judging crowd sourced creative works;

FIG. 2 is an example of a method of judging crowd sourced creative works; and

FIG. 3 is a pie chart depicting an example of the sharing of all revenue pool generated by consumption of all sourced creative crowd works on the provider system.

### DETAILED DESCRIPTION

The following detailed description is exemplary in nature and is not intended to limit the scope, applicability, or configuration of the invention. Rather, the following description provides practical illustrations for implementing various exemplary embodiments. Utilizing the teachings provided herein, those skilled in the art may recognize that many of the examples have suitable alternatives that may be utilized.

Various systems and methods described herein include a provider service for curated crowd sourced digital creative content in which judges accurately evaluate and promote creative content provided by the public. The creative content provided by the provider service is curated through the use of judges who evaluate each creative work. The creative content is provided to the judges in a random and anonymous fashion to avoid bias or manipulation. The opinions of the judges are consolidated and used by the provider service to determine whether or not each creative work will be made available to consumers and/or how it will be made available. For example, in some embodiments, all creative works may be available to consumers regardless of the scores they received, however, only those creative works which scored above a particular threshold may be included as part of a defined subset of works, such as a catalogue, which may be separately provided and/or promoted to consumers.

In some embodiments, the judges themselves may be evaluated and/or scored by the provider service based upon their ability to predict the popularity of creative works. The results of this evaluation and/or score may be provided to the judges as an incentive to perform well or may not be provided to the judges. In some embodiments, only the scores of those judges who are themselves evaluated or scored above a certain threshold (referred to herein as high quality judges) may be considered in the determination of whether or not a creative work will be made available to consumers and/or how it will be made available.

In some alternatives, the judges who curate the creative works may receive a share of the revenue generated by the creative works. This may provide an additional incentive for the judges to act as judges and/or to promote creative works and/or the provider service. For example, for each creative work, consumers consume the creative content to generate revenue, such as by a subscription membership or by advertising provided in conjunction with streaming or downloading the work. The more a creative work is consumed, the more revenue it generates through the provision of more advertising content and through a greater the share of the subscription revenue being attributed to it. For each curated creative work provided to consumers, a portion of the revenue generated by the work may be provided to the judges. However, this share of the revenue may only be provided to high performing judges who approved of the creative content and low performing judges may be excluded. In this way, judges may be incentivized to review more creative works in order to participate more and to perform well by accurately predicting popular works in order to participate in the share of the revenue. The judges may also be incentivized to promote the creative works which they approved, and the use of the provider service in general, in order to increase consumption of the creative works and the revenue they generate and thereby increase their own revenue as judges.

Artistic content may be created by members of the public and supplied to the provider system. The members of the public may be any creators of artistic content, worldwide, with access to the provider service such as through the internet. These public content creators may be amateurs, professionals or hobbyists in their artistic fields, for example. Their works may be acoustic works such as musical performances or podcasts, visual works such as photographs or other images or movie films, or literary works such as stories or books, or a combination of more than one category such as audiobooks, for example. Any artistic or creative work which may be transmitted in a digital format may be supplied by the public to the provider system and then curated and provided to consumers of the provider system. The creative works may be provided to consumers in a streamed format or as a temporary or permanent download, for example, depending upon the type of artistic work and the design or options of the provider system.

Judges who curate the creative works provided by the public may be ordinary individual people. In some embodiments, the judges may be consumers of the provider system who volunteer or request or apply to be judges. In some embodiments, the provider system may restrict which consumers may act as judges. For example, the provider system may only allow consumers to be judges if they have a subscription to the provider system.

The provider system, according to exemplary methods and processes described herein, may include digital electronic circuitry of various types including integrated circuits, hardware, software, and/or other components in various combinations. It may include machine readable medium such any type of memory which may be used to provide machine instructions and/or data to a processor, which may implement the methods described herein using one or more computer programs. The machine readable medium may store machine instructions in a non-volatile or non-transient manner (such as in a solid state medium) and/or in a transient manner (such as in a cache or random access memory).

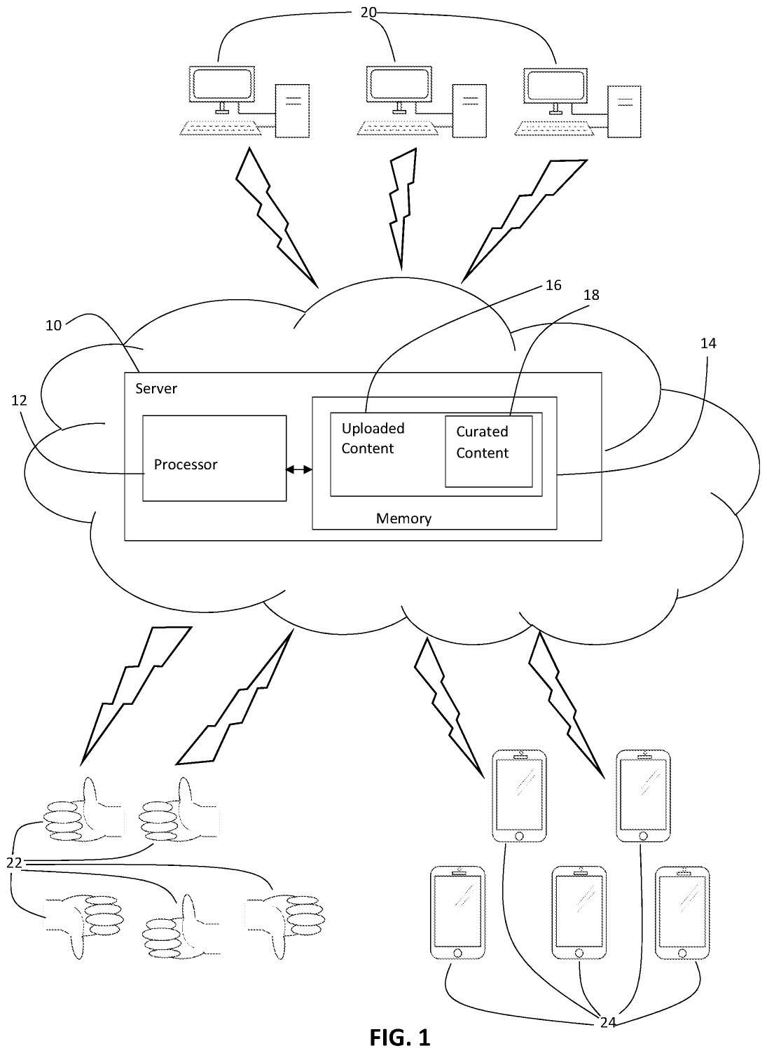

An example of a provider system that may be used in various embodiments is shown in FIG. 1. The system includes one or more servers such as server 10 including one or more processors 12 for processing and one or more memory components 14, one or both of which may be part of and/or separate from the server 10. The server 10 may be configured to execute programming to perform the various steps described herein. The memory 14 may store data such as the creative content uploaded by content creators 16 and the curated creative content 18 provided to consumers. The memory 14 may further store programs such as an operating system and one or more application programs which operate on the server 10. As shown in representative form in FIG. 1, a plurality of content creators 20 upload creative works to the server 10. A plurality of judges 22 review the creative works and provide their reviews to the system 10. The system 10 provides curated creative works to its users who are consumers 24.

The provider system for receiving and providing the creative content may be a system, such as a cloud based system, which may provide creative content to consumers through the internet or any other methods of electronically transmitting digital data and may employ a websites or applications such as a mobile application to interface with content creators and consumers. The server 10 may communicate with individuals including content creators, judges, and consumers through the internet, for example. Individuals may employ devices such as mobile computing devices like smart phones or tablets, or computers such as personal computers or laptops, each having interfaces such as screens, processors, non-volatile memory, programming, and input and output units, for example. The devices may employ mobile applications or may comprise devices or programs or website interfaces on personal computers or tablets. Although FIG. 1 depicts content creators 20 using computers and consumers 24 using smart phones, these are representative pictures and are not meant to be limiting. Rather, any individual interacting with the system 10 may use any type of capable device as a user interface.

Creative works may be provided to judges in a randomized fashion. Furthermore, the source of the works may not be provided to the judges to keep the work anonymous. In some embodiments, the provider system may alter the creative works or the data associated with the creative works in order to maintain anonymity. For example, for musical works, the name of the artist may not be provided and no visual materials may be provided to the judges. For visual works such as photographs or paintings, any watermarks or signatures may be removed or obscured. In this way, bias by the judges is eliminated. In addition, content creators and providers (or their friends or those in their employ) are not able to influence the judging because the works are provided at random, with no control by the content creators or providers of who the judge will be, or by the judges of which works they will review.

The judges review of the creative work may result in a score which may be a binary decision regarding whether or not, in the opinion of each judge, the creative work should be provided to consumers. As such, the opinion may simply be a selection between two choices of category placement such as yes (include the creative work in a catalog of available works) or no (exclude or delete the creative work from a catalog of available works). Alternatively, the opinion may be a selection between three of more choices of category placement, such as great (definitely include), good (include), or bad (exclude). Alternative terminology may be used for the voting categories such as lit (incredible, definitely include), alright (good, include) or wack (bad, exclude), depending upon the type of creative work and the nature of the consumer population. Alternatively, each judge reviewing a work may provide a rating, such as a numerical score, of the judge's opinion of the work, on a scale from a value indicating the creative work should absolutely be included, incrementally increasing or decreasing to a value indicating that the creative work should absolutely be excluded. As such, the judge's may score the creative works with a numerical score (such as 1-10) or a category placement (such as pass or fail, etc.) wherein each category may be converted to a numerical score by the system for use in calculating the cumulative score.

In addition to reviewing to work for quality, the judges may also provide the provider system with information about the creative work which may help to categorize the work and which may be used by consumers when searching for a piece of creative work. For example, the provider system may ask judges for information such as providing or confirming the genre of the work, providing or verifying the subgenre, whether or not the work is highly original or atypical, and whether there are works by other content providers which would fit well with the work (for example, for musical works, whether there are other musical works which would sound good with the musical work). Other information which may be requested for musical works may include the gender of the vocalist, whether the work is original, whether the work is a cover, etc. For example, if the creative work is a musical performance, the judges may indicate whether it is voice or instrumental, what type of music it is (e.g. hip hop, rap, R&B, etc.) or other details which may be useful to a consumer searching for a particular type of content. In some embodiments, the judges may indicate whether the work contains explicit or adult content such as profanity or nudity. In some embodiments, the provider system may provide questions to the judges requesting this information. In some embodiments, the judges may provide answers to these questions by selecting an answer from a list of available answers, such as selecting an answer by clicking on one or more selections from a list.

Once the number of judge's reviews for a particular creative work are above a predetermined threshold, such as 10 reviews, 50 reviews, 100 reviews, or 1000 reviews, the system may aggregate the reviews of the judges to determine whether to include the creative work in a catalog of work available to consumers or to exclude it from the catalog and/or remove it from the provider system. In some embodiments, only the reviews from high quality judges may be included in the evaluation, therefore the threshold number of reviews may need to be met using the reviews of high quality judges and the total number of reviews may exceed the threshold. If the judges provide a simple binary yes or no review, for example, the system may require the percentage of yes reviews to be over a threshold value, such as 70%, 80%, or 90%, in order to be available to consumers and/or included in a particular subset of works such as a catalogue of curated works. Alternatively, if the judges provide a numerical score, such as a score with a high number being positive, the system may require a total score or an average score above a threshold value in order to be provided to consumers (or vice versa for scoring systems in which a low number is positive) and/or included in the subset of works.

In some embodiments, the judges receive a share of the revenue generated by the consumers' consumption of the creative works. Revenue may be generated by the creative works in various ways such as through the use of advertising provided to consumers along with their consumption of the creative work. Alternatively or additionally, revenue may be generated other ways such as through a membership or subscription fee paid by consumers. In some embodiments, consumers may select between free use of the provider system along with advertisements, or subscription based use of the provider system without advertisements or with reduced advertisements. Another source of revenue which may be included in various embodiments is tipping, in which users may provide a tip, such as to a creator of creative works or a particular creative work or set of creative works such as a playlist. The tip may be provided in whole to the creator of a particular creative work, or it may be shared with others. For example, the tip may be shared with multiple creators of creative works, such as when a tip is provided to a set of creative works. In some embodiments, the tip may be shared with all creators of creative works. In still other embodiments, it may be included in whole or in part in the revenue pool described later in this application. In some embodiments in which the tip is split, the proportion of a tip that is provided to a creator of a creative work or works may vary depending upon the amount of consumption of that creative work or works by consumers, with higher consumption resulting in a greater proportion of the tip.

In some embodiments, the system may only be available by a subscription, while in other embodiments subscription may be optional. In some embodiments which include a subscription option, the subscription may allow the consumers certain capabilities which are not available to nonsubscribers. For example, consumers who participate as subscribers may have exclusive benefits such as early access to new creative works (before nonsubscribers) and/or the enhanced ability to impact the ratings or advancement of an artist and/or a creative work such as by more prominent placement of comments for enhanced visibility by other consumers. In some embodiments, only subscribers may be able to tip and the consumers may register for tipping as part of their consumer profile of their subscription. In other embodiments, any consumer may have the capability of tipping, whether or not the consumer is a subscriber.

Revenue may be attributed to creative works depending upon the amount of their consumption. For example, for creative works which are streamed, such as songs, the number of times the creative work is streamed (out of all streaming of creative works during a time period) may determine the amount of revenue attributed to that creative work for that time period. The attribution of all revenue may be divided pro rata in this way. As such, all revenue, whether generated through advertising or subscription, for the time period may be attributed to each creative work consumed during that time period according to the amount of its consumption. As such, whether the revenue is generated through advertisements or subscriptions, the more a work is consumed, the more revenue that is attributed to it.

In various embodiments, a portion of the revenue attributed to each creative work may be shared with each of the judges in the judge pool who favorably reviewed the creative work. Since the amount of revenue attributed to a creative work depends upon its consumption, the more a work is consumed by consumers, the more revenue a judge may earn.

The provider system may allow judges to promote particular creative works within the system, such as through their own platforms such as web pages, lists or articles. Alternatively or additionally, the judges may promote particular creative works outside of the provider system such as through other social media. The judges may do this in order to increase their own popularity. In some embodiments, the provider system may provide non-monetary incentives to judges to promote content and/or to score works accurately (accurately predict popular works). For example, in some embodiments, the judges may earn points through accurate judging (and optionally lose points through poor judging), and these points may provide an individual incentive to the judges to judge well. In some embodiments, the score may be publicly visible and may increase the judges' standing on the provider platform, such as by improving the perception of their judging abilities in the eyes of consumers.

In some embodiments, the provider system may provide a monetary incentive to judges to act as judges, to accurately predict popular works, and to promote works which they reviewed favorably. For example, if the judges may receive a share of revenue attributed to the songs they reviewed favorably, they may promote these songs since their promotion may lead to more consumption of the creative work by consumers. This promotion is beneficial to all participants of the provider system, including the content creators as well as the provider system and the judges, since it increases revenue. Therefore, by providing revenue to the judges based upon the quantity of consumption of the creative works they approved, it creates an incentive to the judges not only to review and discover new works but also to promote them, which in turn increases revenue for all other parties.

In embodiments which provide a share of revenue to the judges, the provider system may only provide a share of the revenue attributed to a creative work to those judges who favorably reviewed that creative work. Judges who negatively reviewed the creative work the creative work may be excluded from sharing in the revenue attributed to the creative work. However, without some controls, such a system could encourage judges to favorably review all creative works in order to maximize their receipt of revenue. In order to prevent this and to assure that the judges are good actors, the provider system may only provide a share of the revenue to judges who provide high quality reviews as determined by their correlation to public opinion. As such, the provider system may only provide a share of the revenue generated by a creative work to those judges who positively reviewed the creative work and who are high quality judges.

The quality of the judging provided by each judge may be determined by the provider system based upon the statistics of the consumers' consumption of the creative works which each judges reviewed. For example, judges who statistically have a high degree of correlation with the consumers' opinions and/or other judge's opinions when predicting popular works may be considered high quality judges who's scores are included in the evaluation of the work and who, in some embodiments, receive a portion of the revenue attributed to the content which they approved or rated highly. The scores of low quality judges, who statistically have a poor record of predicting which works are popular with the consumers and/or other judges, may be excluded from the evaluation of the work and, in relevant embodiments, may be excluded from receiving a portion of the revenue generated by the content which they approved or rated highly. For example, a judge may be scored based upon the percent agreement of the judges' reviews with the final evaluation of the work determined by the reviews of all judges in the judge pools for each work. For example, if a judge evaluates 10 works and judges them all as passing for inclusion, but the final score of the judge pool results in only 8 of the 10 works passing, the judge may have a score of 80%. The quality scores of judges may be updated periodically such as daily, weekly or monthly, based upon the final judgement of the works they reviewed, or they may be updated each time a work which they judged is evaluated by the system as passing (being included in the subset of curated and approved songs) or failing (being excluded from the subset of works). A judge may receive a quality score once the judge has judged a number of works above a threshold such as 20 works and these works have been evaluated by the system based upon the complete judge pool. The judges' quality scores may be determined based upon their entire judging history or may include only the most recent judging history. For example, only the judges' most recent 20 reviews may be included in their quality scores in order to keep the quality score current as well as to improve the judges' ability to modify their scores. In some embodiments, the minimum number of reviews required to receive a quality score may be identical to the number of reviews used for the quality score, while in other embodiments the quality score may be determined using more than the minimum number of scores.

In some embodiments, the judges may be kept unaware of their quality scores. This may serve to encourage judges to continue judging, since they do not know whether or not their scores will be included and, in relevant embodiments, they do not know if they will partake in the revenue of the works they judge. It may also prevent the judges from attempting to maintain only marginally acceptable scores in order to still qualify for revenue sharing while approving as much content as possible. In other embodiments, the judges may have access to their quality scores and/or may be made aware of their scores so that they may attempt to improve their scores and therefore perform better as judges. In embodiments in which high quality judges may receive a portion of the revenue attributed to the works they approved, the judges may be informed that they need to maintain a particular minimum quality score to participate in sharing the revenue. However, the judges may not be informed that their reviews will not count if their quality scores are below a particular threshold. In this way, low quality judges will continue to judge and, if their intent is to act as good judges, they will attempt to improve their judging and their quality scores. However, if their intent is to be a bad actor by intentionally reviewing works poorly for malicious or disruptive purposes, they too will continue to make reviews but, unbeknownst to the malicious judges, their reviews will not be counted. This is to prevent such malicious judges from repeatedly creating new accounts in order to have their intentionally poor reviews count.

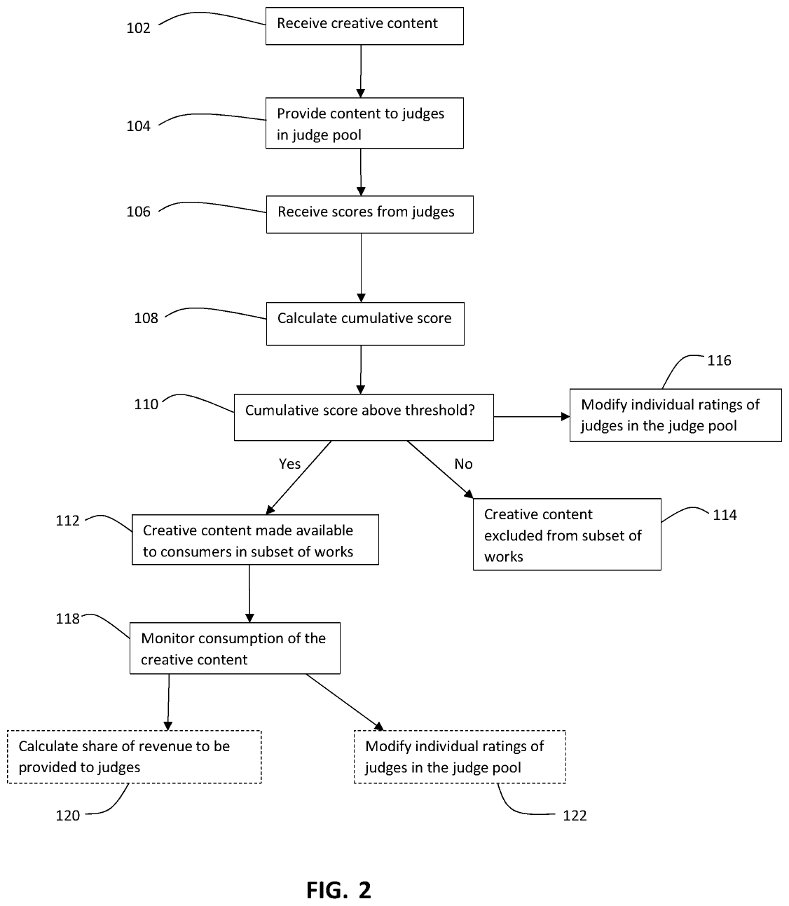

FIG. 2 depicts a flow chart of a process used by a provider system according to various embodiments. In a first step 102, the system receives a work of creative content uploaded by a content creator. The system then provides the creative work to a plurality of judges in step 104 in a random and anonymous fashion. The pool of judges may be randomly selected, in order to avoid bias, and includes a sufficient number of judges in order to accurately assess the quality of the work. For example, the system may provide the creative work to between about 50 and 100 judges or between about 50 and 500 judges or more. The number of judges who have access to the work may be more than the number needed to make a determination regarding whether to provide the work to consumers, since some judges who have access to the work will not provide an evaluation or their evaluation may not be considered by the provider system. In some embodiments, the system may notify the judges that they have a new creative work to review, such as by sending them a notification in the form of a text or other electronic message. In other embodiments, the judges may not be specifically notified but rather may find new content to review by accessing the provider system through an application or website. The judges then access the new creative work and evaluate it by listening to it, looking at it, or reading it, depending upon what type of creative work it is. In step 106, the system receives the score from the judges. This score may be a binary vote (or a vote selection between 3 or more options) or a numerical score, as described above. The system may also receive other information regarding the work from the judges, such as a classification of the type of creative work it is such as the genre, subgenre, or other information.

Once an adequate number of judge scores have been received to evaluate the creative work, such as a number of scores above a predetermined threshold, the system combines the scores of the judges in order to determine a cumulative score in step 108. The cumulative score may or may not be a sum total score. Regardless of how it is calculated, it may take into account the score of each judge (or in some embodiments, only each high quality judge) in some way. For example, in embodiments in which the judges provide a binary score equating to a yes or no, the cumulative score may be a mathematical calculation equating to the percent of judges which scored the work positively (as a yes). In embodiments in which the judges provide a numerical score, the cumulative score may be a mathematical calculation of an average judge score or a total sum score for a set number of judges, for example. In some embodiments, the passing scores may be accorded a positive value and the failing scores a negative value, which may be added together. For example, in a 3 option voting system, the best value for a top vote of a work may be a 2, while the value of an ordinary passing vote may be a 1 and the value of a failing vote may be −1. The values of the scores for all votes (or all votes which are counted) may be added together and divided by the total number of votes (or all votes which were counted). This score may be multiplied by 100, for a score range of −100 to 200.

Regardless of how the cumulative score is calculated, the system compares the cumulative score to a threshold value in step 110. If the cumulative score is above a predetermined threshold, the creative work may be included with the other approved material and may be provided to consumers in a subset of curated and approved works in step 112. If the cumulative score is below a predetermined threshold, it may be excluded from the material provided to consumers in the subset of curated and approved works in step 114. Alternatively, if a low score indicates a favorable review, then a creative work may be included in the approved material if it is below the threshold and excluded if it is above the threshold. Works having cumulative scores equal to the threshold may be included or excluded as desired, depending upon the rules of the provider system. Works which are excluded from the subset of curated and approved works may still be available to consumers outside of this curated and approved set or alternatively may be excluded from the provider service and may not be available to consumers.

The final judgement of the work as passing for inclusion or being excluded in step 110 is used to recalculate the quality scores of the judges in the judge pool in step 116. For those judges in the judge pool whose review conforms to the final judgement of the work, their quality scores will improve. For those judges in the judge pool whose review did not conform with the final judgement of the work, their quality scores will fall. For example, if a work is approved for inclusion in the subset, the quality scores of those judges who reviewed a work favorably will improve, while those who reviewed a work unfavorably will worsen. If a work is excluded from the subset, the quality scores of those judges who reviewed the work unfavorably will improve, while those who reviewed it favorably will worsen.

Once material is made available to consumers in the subset of works in step 112, the system monitors the consumption of the creative content in step 116. For example, in the case of musical works, the system may monitor the number of times which the musical work is streamed by consumers over a certain period of time. In the case of photographs, the system may monitor the number of times the work is downloaded by consumers during a certain period of time. Information regarding the consumption of the work by consumers may be employed by the provider system in various ways as described below.

In optional step 120, the amount of consumption of the work by consumers may be employed by the provider system to calculate the revenue attributed to the work and, in embodiments which include the sharing of revenue with judges, the amount of revenue that each judge will receive. The exact calculations may be performed in various ways, depending upon the particular rules selected for the provider system. However, the calculation may be directly dependent upon the amount that the creative work is consumed by consumers, such that the more it is consumed (the more popular it is), the more revenue is attributed to each work and in turn to each judge (having a high enough judge rating) that approved the song. As such, when the provider system includes this feature, the system creates an incentive for judges to not only act as judges but also to perform judging at a high standard that strongly predicts public response (in order to partake in the revenue) and to promote the works that they approved (in order to maximize the revenue earned by the works they approved).

In optional step 122, the provider system may employ the information regarding the use of the work approved by the judges to modify each judge's rating. The popularity of a work with consumers may depend not only upon the quality of the work but also upon its promotion. Therefore, the provider system may increase a judge's quality score if a work the judge approves is highly consumed or decrease the judge's quality score if consumption of the work is low as an incentive to promote the works the judge approves. For example, if a judge approved of a work or rated it highly and the work turned out to be popular (as evidenced by a high level of consumption), the judge's rating may improve. If the judge approved of a work or gave it a high rating but the work turned out not to be popular (as evidenced by a low level of consumption), the judge's rating may worsen.

As mentioned above, various formulas and methods may be used to calculate a judge's individual quality rating and the judge's share of the revenue produced by the work. What follows is therefore just one example of how these values may be calculated.

The calculation may begin with the revenue pool, which may be all revenue generated by all works provided to consumers by the provider system in a particular time period, such as a month. The revenue pool includes all revenue generated through advertisements as well as through subscriptions, which may be allocated on a pro rata basis to each period of time (such as month) covered by the subscription. The revenue may be allocated to each work pro rata, depending upon its consumption. For example, a work that accounts for 1% of all consumption on the provider service may be allocated 1% of the revenue, to be split as discussed below. In some embodiments, such as embodiments in which the service provider provides multiple types of works, the revenue generated by all works may be divided into separate pools according to criteria such as the type of work. In this way, each revenue pool may include all revenue generated by all works of the same type or other criteria. It may be useful to divide the revenue into multiple revenue pools in this way if there are different agreements with regard to the values of the fees and percentages provided to the parties for different types of works. In this way, all works within a particular revenue pool may be subject to the same arrangements with regard to the splitting of the revenue.

This revenue pool(s) may be split in various ways as agreed to by the provider service and the parties involved or as offered by the provider service. For example, a predetermined percentage of the revenue pool may be provided to the provider service as a fee. Another predetermined percentage of the revenue pool may be provided to rights holders including the content creators and others such as copyright holders who may have rights in the works. This portion may be referred to as the rights holder pool. The pro rata portion of the rights holder pool attributed to each work may be split among all of the rights holders for each work that were consumed during the time period, and may be split in various way. For example, for a musical work, both the musician who performed the work and the composer who wrote the work may have rights to the work and may split the portion of the rights holder pool attributed to that work. Another predetermined percentage of the revenue pool may be provided to the judges, and this portion may be referred to as the judge pool, though the judge pool is optional and in some embodiments there may not be a judge pool. The judge pool may be split among all judges who qualify to participate in sharing the revenue (by having a high enough judge quality score). The share of the judge pool received by each judge will vary depending upon the number of works approved by each judge as well as the amount of revenue attributed to each work approved by the judge. So, for example, a judge that approved of a very popular work (to which a greater portion of the revenue will be attributed) will receive a greater share of the judge pool than a judge that approved a less popular work. Likewise, a judge who approved many works will receive a greater share than a judge who approved fewer works, though this will depend upon the popularity of the individual works approved by each judge.

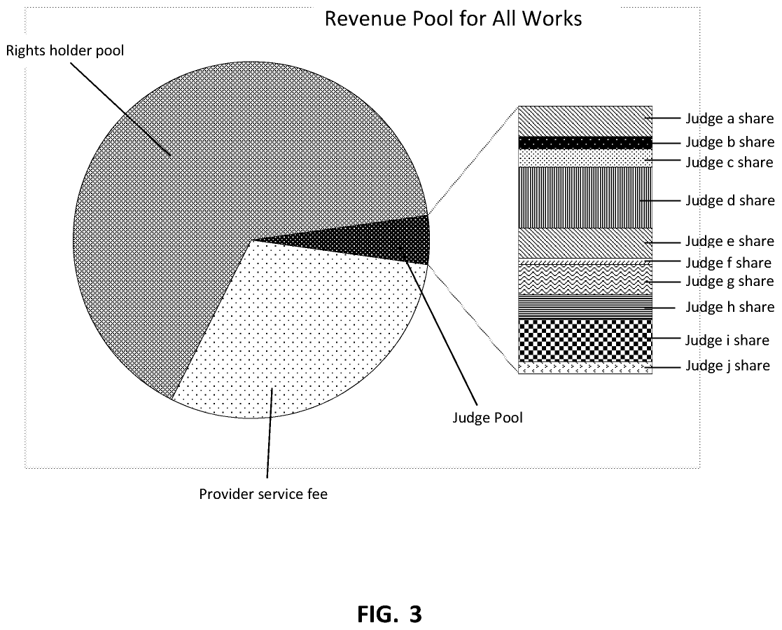

An example of a split of a revenue pool is shown in FIG. 3 in the form of a pie chart. The actual sizes of the pieces of each piece of the pie may be different than what is shown, and the amounts shown in this example are just for illustration purposes. The entire pie represents the revenue pool for all works (or all of a group of works), which is split into a provider service fee, a rights holder pool, and a judge pool. Additional portions of the revenue pool could be allocated in other ways, not shown in this chart. As explained above, the rights holder pool may be split among various parties, but these further splits are not shown in this figure. The judge pool is split among judges a-i, though the judge pool may often be split by many more judges, perhaps hundreds or thousands. In this figure, the judge pool is shown as split among 10 judges for ease of visualization in the chart. It can be seen that some judges receive larger shares than others, reflecting the greater popularity of the works (and therefore greater revenue attributed to those works) which the judge approved and/or the greater number of works which the judge approved.

An example of a calculation that may be used to determine the share provided to a judge is shown below:

Judge share=(Judge_score*1/total_participants)*Judge_Pool*Pro_Rata_Share

In this formula, Judge_score is the judge's individual score. The judge's score may be a percentage score, such as 75%. Although included in the formula above, the judge score may or may not be included in the formula. When included, it may give the judges an additional incentive to perform well, but it may optionally not be used in calculating the judge share. Total participants is the number judges who qualify for revenue sharing who approved the work. The Judge Pool is the percent of the revenue pool allocated to the judges. Pro rata share is the fraction of the total revenue of all works included in the revenue pool which is attributed to the particular work based upon the share of consumption.

An example of how this formula may be used is as follows. A particular creative work passed the judges evaluation based upon the opinions of 100 judges, with 80 judges approving the work and 20 judges rejecting the work. The 20 judges who did not approve the work do not share in the revenue for that work. Of the 80 judges who approved the work, 50 have a high enough judge score to participate in revenue sharing, while 30 do not. In this example, the share of revenue for each judge is shown below, with 50 judges participating in the revenue share. Again, although included below, use of the judge's score in calculating the judge share is optional.

Judge share=Judge_Score* 1/50*Judge_Pool*Pro_Rata_Share_of_Plays

Continuing this example, assume the number of consumption of all works on the provider system is 10 million during one month, and of these consumptions 1 million are the work described above. In this example, the pro rata share is therefore 10% of the revenue pool. The judge pool is also 10% in this example, though this number could be different, such as 5% or 12%, depending upon the agreement of the parties. The revenue for the month is $1 million. Applying these hypothetical numbers to a judge with a judge score of 80%, the share of the revenue for the month to be provided to each judge who approved the work is:

Judge share=(80%*(1M/10M)*$1M*10%)/50=$160

A provider system with judging as described herein provides an incentive for judges to perform fair and accurate judging and to promote the works which they approve. It makes the process of discovering new high quality works more fun and engaging for the judges. It also improves the quality of the crowdsourced works available to consumers, helping consumers find the type of new works which they like most.

In the foregoing description, the inventions have been described with reference to specific embodiments. However, it may be understood that various modifications and changes may be made without departing from the scope of the inventions.

1. A method for providing crowdsourced creative works comprising:
receiving creative works in a digital format;
providing the creative works to judges in a random and anonymous manner;
receiving scores of the creative works from the judges;
calculating a cumulative score using the scores received from the judges; and
including the creative works in a subset of works available to consumers on an digital platform only if the cumulative score qualifies for inclusion based upon a threshold value.

2. The method of claim 1 wherein the digital platform comprises a service providing electronic transmission through the internet or through an application.

3. The method of claim 2 wherein the creative work comprises a piece of music.

4. The method of claim 3 further comprising streaming the creative works in the subset of creative works to consumers on demand.

5. The method of claim 1 wherein any consumer may act as a judge but only the scores of a subset of judges are used for calculating the cumulative score.

6. The method of claim 5 wherein the subset of judges comprises judges having quality scores above a threshold value.

7. The method of claim 6 wherein the quality scores of the judges are determined using the popularity of plurality of creative works scored by the judges.

8. The method of claim 7 wherein the judges are unaware of whether or not their scores count in the cumulative scores of the creative works.

9. The method of claim 1 wherein creative works for which the cumulative scores do not qualify for inclusion are not provided to consumers on the digital platform.

10. The method of claim 1 further comprising monitoring amount of consumption of the creative works; and
providing a share of revenue attributed to each creative work to the judges who approved the creative work and have quality scores above a threshold value;
wherein the share of revenue attributed to each creative work is dependent upon the amount of consumption of the work.

11. The method of claim 10 wherein revenue earned by the digital platform is split between the digital platform service, creators of the creative works, and judges.

12. The method of claim 1 wherein the scores received from the judges comprise numerical scores or category placements.

13. A method for providing crowdsourced creative works comprising:
receiving creative works in a digital format;
providing the creative works to judges in a random and anonymous manner;
receiving scores of the creative works from the judges;
comparing a quality score for each judge to a threshold quality score to determine which judges are high quality judges;
calculating cumulative scores for the creative works using only the scores received from high quality judges;
including the creative works in a subset of works available to consumers on a digital platform service only if the cumulative score qualifies for inclusion based upon a threshold value.

14. The method of claim 12 wherein the creative works comprise pieces of music and wherein the method further comprises streaming the pieces of music to consumers.

15. The method of claim 12 wherein the judges are unaware of whether or not they qualify as high quality judges.

16. The method of claim 12 further comprising:
monitoring an amount of consumption of each creative work; and
calculating a share of revenue attributed to each creative work to be provided to the judges, wherein the share of revenue attributed to each creative work is dependent upon the amount of consumption of the work.

17. The method of claim 15 wherein revenue is only shared which the judges who qualify as high quality judges.

18. A digital creative content provider system comprising:
a provider server configured to:
receive creative works in a digital format;
provide the creative works to judges in a random and anonymous manner;
receive a score of the creative works from the judges;
calculate a cumulative score for the creative works from the judges; and
make the creative works available on a digital platform to consumers only if the cumulative score qualifies based upon a threshold inclusion value.

19. The system of claim 18 wherein the server is further configured to;
calculate quality scores of a judges using scores of creative works provided by the judges in the past; and
compare the quality scores of the judges to a threshold quality score;
wherein only the scores of judges who qualify for judging based upon their quality scores are included in the cumulative scores of the creative works.

20. The system of claim 18 wherein the server is further configured to:
monitor an amount of consumption of each creative work; and
calculate a share of revenue attributed to each creative work to be provided to the judges, wherein the share of revenue attributed to each creative work is dependent upon the amount of consumption of the work.
